(19) United States
(12) Patent Application Publication
(10) Pub. No.: US 2023/0368514 A1
(43) Pub. Date: Nov. 16, 2023

(54) MULTI-CELL NON-COHERENT OVER-THE-AIR COMPUTATION FOR FEDERATED EDGE LEARNING

(71) Applicant: UNIVERSITY OF SOUTH CAROLINA, COLUMBIA, SC (US)

(72) Inventors: MOHAMMAD HASSAN ADELI, COLUMBIA, SC (US); ALPHAN SAHIN, COLUMBIA, SC (US)

(21) Appl. No.: 18/312,656

(22) Filed: May 5, 2023

Related U.S. Application Data
(60) Provisional application No. 63/341,045, filed on May 12, 2022.

(51) Int. Cl. G06V 10/82; G06V 30/194; H04L 5/00

(52) U.S. Cl. CPC G06V 10/82; G06V 30/194; H04L 5/0007

(57) ABSTRACT

A system and method are disclosed for a framework where over-the-air computation (OAC) occurs in both uplink (UL) and downlink (DL), sequentially, in a multi-cell environment to address the latency and the scalability issues of federated edge learning (FEEL). To eliminate the channel state information (CSI) at the edge devices (EDs) and edge servers (ESs) and relax the time-synchronization requirement for the OAC, we use a non-coherent computation scheme, i.e., orthogonal signaling based majority vote (MV). Multiple ESs function as the aggregation nodes in the UL. Each ES determines the MVs independently. After the ESs broadcast the detected MVs, the EDs determine the sign of the gradient through another OAC in the DL. Hence, inter-cell interference is exploited for the OAC. Convergence of the non-convex optimization problem for the FEEL is proven with the proposed OAC framework. Efficacy of the proposed method is numerically evaluated by comparing the test accuracy in both multi-cell and single-cell scenarios for both homogeneous and heterogeneous data distributions.

### PRIORITY CLAIM

The present application claims the benefit of priority of U.S. Provisional Patent Application No. 63/341,045, titled Multi-Cell Non-Coherent Over-The-Air Computation for Federated Edge Learning, filed May 12, 2022, and which is fully incorporated herein by reference for all purposes.

### BACKGROUND OF THE PRESENTLY DISCLOSED SUBJECT MATTER

Over-the-air computation (OAC) refers to the computation of mathematical functions by exploiting the superposition property of wireless multiple-access channel [1]. It has initially been considered in wireless sensor networks to reduce the latency due to a large number of nodes [2]-[4]. Recently, OAC has shown it is also a prominent solution to address the latency issue of federated edge learning (FEEL) [5] or distributed training problems in a wireless network [6]. Nevertheless, apart from a few works [7], FEEL with OAC is primarily investigated in a single cell in the uplink (UL), although the practical wireless networks often consist of multiple cells. In this disclosure, we address this issue and propose a framework for FEEL based on a non-coherent OAC scheme in both UL and downlink (DL) in a multi-cell environment.

One of the major challenges in the OAC is the detrimental impact of wireless channels on the coherent symbol superposition. To address this issue, a majority of the state-of-the-art solutions rely on pre-equalization techniques. For instance, broadband analog aggregation (BAA) over orthogonal frequency division multiplexing (OFDM) with truncated-channel inversion (TCI) is investigated to obtain unbiased estimates of the weights or gradients^{[8-9]}. One-bit broadband digital aggregation (OBDA), inspired by distributed training by majority vote (MV) with the sign stochastic gradient descend (signSGD)^{[11]}, is proposed to facilitate the implementation of FEEL for a practical wireless system, which also uses TCI^{[10]}. Alternatively, the conjugate of the channel can be utilized instead of TCI^{[12]}. Further, it is assumed that the channel state information (CSI) for each edge device (ED) is available at the edge server (ES)^{[13-14]}. The impact of the channel on OAC is mitigated through beamforming techniques.

The state-of-the-art OAC techniques are often suitable for a single cell where the OAC occurs in the UL due to the pre-equalization. In addition, pre-equalization techniques require sample-level precise time synchronization, which causes another shortcoming when multiple aggregation nodes exist in a wireless network. Prior art investigates for FEEL in a single cell scenario by non-coherent computation through frequency-shift keying (FSK)-based MV (FSK-MV) and pulse-position modulation (PPM)-based MV (PPM-MV)^{[15-16]}. The main strategy in these aforementioned studies is to dedicate two resources where either of the two resources are activated based on the sign of the gradient. The MV at the ES is detected through an energy detector. Since the information is not encoded in the amplitude or the phase in this strategy, the need for CSI at the EDs and the ES are eliminated, and the precise time-synchronization requirement is relaxed. Because of these unique features, we consider non-coherent OAC in a multi-cell environment.

### SUMMARY OF THE PRESENTLY DISCLOSED SUBJECT MATTER

In this disclosure, we propose an OAC framework where OAC occurs in both UL and DL in a multi-cell environment with FSK-based MV. As opposed to a single-cell solution, multiple ESs first detect the MVs through the UL OAC. Afterward, each ED determines the sign of the gradient by aggregating the ESs' signals in the DL with another OAC. We show the convergence of the non-convex loss function problem for FEEL with the proposed scheme and evaluate the proposed framework numerically. We show the efficacy of the proposed framework by comparing it with a single-cell scenario for both homogeneous and heterogeneous data distributions.

The disclosure deals with a system and method for a framework where OAC occurs in both UL and DL, sequentially, in a multi-cell environment to address the latency and the scalability issues of FEEL. To eliminate the CSI at the EDs and ESs and relax the time-synchronization requirement for the OAC, we use a non-coherent computation scheme, i.e., FSK-based majority vote (MV) (FSK-MV). With the proposed framework, multiple ESs function as the aggregation nodes in the UL and each ES determines the MVs independently. After the ESs broadcast the detected MVs, the EDs determine the sign of the gradient through another OAC in the DL. Hence, intercell interference is exploited for the OAC. In this disclosure, we prove the convergence of the non-convex optimization problem for the FEEL with the proposed OAC framework. We also numerically evaluate the efficacy of the proposed method by comparing the test accuracy in both multi-cell and single-cell scenarios for both homogeneous and heterogeneous data distributions.

Regarding notations herein: E[⋅] is the expectation operation; I[⋅] is the indicator function; and the function sign (⋅) results in 1, −1, or ±1 at random for a positive, a negative, or a zero-valued argument, respectively

It is to be understood that the presently disclosed subject matter equally relates to apparatus and system subject matter as well as associated and/or corresponding methodologies. One exemplary such method relates to a non-coherent over-the-air computation methodology occurring in both uplink (UL) and downlink (DL), sequentially, in a multi-cell environment for federated edge learning (FEEL) without using channel state information (CSI) at a plurality of edge devices (EDs) or at edge servers (ESs). Such methodology preferably comprises providing a distributed machine-learning model to be trained with the update vectors received at a plurality of edge servers (ESs) as transmitted from a plurality of edge devices (EDs); and conducting methodology operations preferably comprising transmitting local updates vectors as weighted votes with respective of the plurality of edge servers (ESs) functioning as aggregation nodes in the UL via a wireless multi-cell environment, independently detecting orthogonal signaling based majority vote (MV) data at each ES in the UL, broadcasting the detected MVs from the ESs, and inputting the MVs into the machine-learning model to be updated, wherein the EDs determine the sign of the gradient through over-the-air computation using orthogonal signaling based majority vote (MV) in the DL.

In some embodiments of the foregoing methodology, such methodology may further include providing one or more processors; and providing one or more non-transitory computer-readable media that store instructions that, when executed by the one or more processors, cause the one or more processors to perform the methodology operations.

Other example aspects of the present disclosure are directed to systems, apparatus, tangible, non-transitory computer-readable media, user interfaces, memory devices, and electronic devices for ultrafast photovoltaic spectroscopy. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a non-coherent over-the-air computation system for both uplink (UL) and downlink (DL) channels in a multi-cell environment, for federated edge learning (FEEL) without using channel state information (CSI) at a plurality of edge devices (EDs) or at edge servers (ESs). Such system preferably comprises a machine-learning model training to process data received at a plurality of edge servers (ESs) as transmitted from a plurality of edge devices (EDs); one or more processors; and one or more non-transitory computer-readable media that store instructions that, when executed by the one or more processors, cause the one or more processors to perform operations. Such operations preferably comprise transmitting local update vectors as weighted votes with respective of the plurality of edge servers (ESs) functioning as aggregation nodes in the UL channel via a wireless multi-cell environment, independently detecting orthogonal signaling based majority vote (MV) data at each ES in the UL channel, broadcasting the detected MVs from the ESs, and inputting the MVs into the machine-learning model to be updated, wherein the EDs determine the sign of the gradient through over-the-air computation using orthogonal signaling based majority vote (MV) in the DL channel.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying figures, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1A illustrates corresponding transmitter and receiver block diagrams for upload (UL) over-the-air computation (OAC) with frequency-shift keying (FSK)-based majority vote (MV) (FSK-MV);

FIG. 1B illustrates a block diagram of upload (UL) features for over-the-air computation (OAC) with multi-cell environment, illustrating interference across the cells (i.e., among the EDs or the ESs) as exploited in UL for gradient aggregation;

FIG. 1C illustrates a block diagram of download (DL) features for over-the-air computation (OAC) with multi-cell environment, illustrating interference across the cells (i.e., among the EDs or the ESs) as exploited in DL for gradient aggregation;

FIG. 2A graphically illustrates test accuracy versus communication round in a single cell (|G|=30000) under homogeneous data distribution (all classes);

FIG. 2B graphically illustrates test accuracy versus communication round in a single cell (|G|=30000) under heterogeneous data distribution (personalized);

FIG. 3A graphically illustrates test accuracy versus communication round for multiple cells (|G|=30000) under homogeneous data distribution (all classes);

FIG. 3B graphically illustrates test accuracy versus communication round for multiple cells (|G|=30000) under heterogeneous data distribution (personalized);

FIG. 4A graphically illustrates distribution of the test accuracy versus communication round in a single cell (×: ES, ○: ED, towards zero: Low test accuracy, towards 100: High test accuracy, |G|=30000) under homogeneous data distribution (all classes);

FIG. 4B graphically illustrates distribution of the test accuracy versus communication round in a single cell (×: ES, ○: ED, towards zero: Low test accuracy, towards 100: High test accuracy, |G|=30000) under heterogeneous data distribution (personalized);

FIG. 5A graphically illustrates distribution of the test accuracy versus communication round for multiple cells (×: ES, ○: ED, towards zero: Low test accuracy, towards 100: High test accuracy, |G|=30000) under homogeneous data distribution (all classes);

FIG. 5B graphically illustrates distribution of the test accuracy versus communication round for multiple cells (×: ES, ○: ED, towards zero: Low test accuracy, towards 100: High test accuracy, |G|=30000) under heterogeneous data distribution (personalized);

FIG. 6A graphically illustrates distribution of the test accuracy versus probability for multi-cell federated learning (FL) with the proposed over-the-air computation (OAC) with the training based on only local data after 400 iterations (|G|=5000) under homogeneous data distribution (all classes); and

FIG. 6B graphically illustrates distribution of the test accuracy versus probability for multi-cell federated learning (FL) with the proposed over-the-air computation (OAC) with the training based on only local data after 400 iterations (|G|=5000) under heterogeneous data distribution (personalized).

Repeat use of reference characters in the present specification and figures is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to an over-the-air computation (OAC) framework where OAC occurs in both uplink (UL) and downlink (DL) in a multi-cell environment with a non-coherent computation scheme based on orthogonal signaling, e.g., frequency-shift keying (FSK)-based majority vote (MV) (FSK-MV), which FSK is an example of orthogonal signaling that is used in the sequel The other examples of orthogonal signaling are pulse position modulation (PPM), chirp-shift keying, and on-off keying (OOK).

### SYSTEM MODEL

Consider a multi-cell wireless network with K EDs and S ESs. We assume that the frequency synchronization in the network is handled through a control mechanism. We consider time synchronization errors among the EDs (and the ESs) and the maximum difference between the time of arrivals of the signals at the desired receiver's location is T_{sync} seconds, where T_{sync} is equal to the reciprocal to the signal bandwidth. We assume that the signal-to-noise ratio (SNR) at an ES is 1/σ_{ES}² when an ED is located at the reference distance r_{UL}. We then set the received signal power of the kth ED at the sth ES as P_{ED}^{k,s}=r_{k,s}^{-α}/r_{UL}^{-α}, where r_{k,s} is the link distance between the kth ED and the sth ES, and a is the path loss exponent. Similarly, we define the DL SNR at an ED is 1/σ_{ED}² when the distance between an ED and an ES is equal to the reference distance r_{DL}. We then set the received signal power of the sth ES at the kth ED as P_{ES}^{k,s}=r_{k,s}^{-α}/r_{DL}^{-α}.

A. Signal Model in Uplink and Downlink

In this disclosure, the EDs in the UL and the ESs in the DL access the wireless channel on the same time-frequency resources simultaneously with N OFDM symbols consisting of M active subcarriers. We assume that the cyclic prefix (CP) duration is larger than T_{sync} and the maximum-excess delay of the channel. Considering independent frequency-selective channels between the EDs and the ESs, the superposed symbol on the mth subcarrier of the nth OFDM symbol at the sth ES for the tth communication round of FEEL can be written as

$${r}_{ES}^{t , s , m , n} = {\sum }_{k = 1}^{K} \sqrt{{P}_{ED}^{s , k}} {h}_{UL}^{t , s , k , m , n} {t}_{ED}^{t , k , m , n} + {ω}_{ES}^{t , s , m , n} , \qquad ( 1 )$$

where h_{UL}^{t,s,k,m,n}∈ [symbol] is the channel coefficient between the sth ES and the kth ED, t_{ED}^{t,k,m,n}∈ [symbol] is the transmitted symbol from the kth ED, and w_{ES}^{t,k,m,n} is the symmetric additive white Gaussian noise (AWGN) with zero mean and the variance σ_{ES}² on the mth subcarrier for mϵ{0, 1, . . . , M−1} and nϵ{0, 1, . . . , N−1}.

Similarly, the received symbol on the mth subcarrier of the nth OFDM symbol at the kth ED for the tth communication round in the DL can be shown as

$${r}_{ED}^{t , k , m , n} = {\sum }_{s = 1}^{S} \sqrt{{P}_{ES}^{s , k}} {h}_{DL}^{t , s , k , m , n} {t}_{ES}^{t , s , m , n} + {ω}_{ED}^{t , k , m , n} , \qquad ( 2 )$$

where h_{DL}^{t,s,k,m,n}∈ [symbol] is the channel coefficient between the sth ES and the kth ED, t_{ES}^{t,s,m,n}∈ [symbol] is the transmitted symbol from the sth ES, ω_{ED}^{t,k,m,n} is the symmetric AWGN with zero mean and the variance σ_{ED}² on the mth subcarrier.

B. Problem Statement and Learning Model

Let wₖ^{(t)}∈ [symbol] ^{Q} denote the model parameters at the kth ED for tth communication round. The local data set containing labeled data samples at the kth ED as {( [symbol] )}∈Dk, where [symbol] and [symbol] are the [symbol] th data sample and its associated label, respectively. In this disclosure, unlike to a classical FEEL problem, to capture the model test accuracy for each ED under heterogeneous data distribution, we define a personalized global loss function at the kth ED for a given wₖ^{(t)} as

$${F}_{k} ( {w}_{k}^{( t )} ) = f ( {w}_{k}^{( t )} , {x}_{ℓ} , {y}_{ℓ} ) , \qquad ( 3 )$$

where [symbol] ₖ={( [symbol] , [symbol] )∈ [symbol] | [symbol] } for g= [symbol] ₁∪ [symbol] ₂∪ . . . ∪ [symbol] ₖ, and [symbol] ₖ is the set of distinct labels in the dataset of the kth ED. f(wₖ^{(t)}, Xₑ, Yₑ) is the sample loss function that measures the labelling error for (Xₑ, Yₑ) for the parameters wₖ^{(t)} at the kth ED.

The personalized federated learning (FL) problem can then be defined as

$${w}_{k}^{*} = arg {min}_{{w}_{k}} {F}_{k} ( {w}_{k}^{( t )} ) . \qquad ( 4 )$$

To solve (4), a full-batch gradient descend with the learning rate η is given by wₖ^{(t+1)}=wₖ^{(t)}−ηgₖ^{(t)}, and

$${g}_{k}^{( t )} = ∇ {F}_{k} ( {w}_{k}^{( t )} ) = ∇ f ( {w}_{k}^{( t )} , {x}_{ℓ} , {y}_{ℓ} ) , \qquad ( 5 )$$

where the ith element of gₖ^{(t)} is g_{k,i}^{(t)}, which is the gradient of Fₖ(wₖ^{(t)}) with respect to w_{k,i}^{(t)}.

In this disclosure, our main goal is to solve (4) in a wireless network consisting of multiple cells, where the data sharing among EDs is not allowed to promote data privacy. To this end, we consider FEEL and reduce the communication latency by adopting an OAC scheme, i.e., FSK-MV^{[15]}, which is originally proposed in the UL for a single cell (i.e., S=1). With this scheme, the kth ED first calculates the local stochastic gradient as

$${\tilde{g}}_{k}^{( t )} = \frac{1}{\vert {n}_{b} \vert} ∇ f ( {w}_{k}^{( t )} , {x}_{ℓ} , {y}_{ℓ} ) , \qquad ( 6 )$$

where \tilde{g}ₖ^{(t)} is the local gradient where its ith is \tilde{g}_{k,i}^{(t)} and [symbol] ₖ⊂ [symbol] ₖ is the selected data batch from the local data set with the batch size, n_{b}=| [symbol] ₖ|.

Each ED then obtains the transmit symbols in the UL as follows: Consider a mapping from i∈{1, . . . , q} to the distinct pairs (m+, n+) and (m−, n−) for m+, m−∈{0, 1, . . . , M−1} and n+, n−∈{0, 1, . . ., N−1}. Based on the value of g̅_{k,i}^{(t)} [symbol] sign(\tilde{g}_{k,i}^{(t)}), the kth ED calculates the symbol t_{ED}^{t,k,m+, n+}and t_{ED}^{t,k,m-, n-}, as ∀i, as

t_{ED}^{t,k,m+, n+}=\sqrt{Eₛ}S_{ED}^{t,k,i} [symbol] [g̅_{k,i}^{(t)}= [symbol] ], (7)

and

t_{ED}^{t,k,m-, n-}=\sqrt{Eₛ}S_{ED}^{t,k,i} [symbol] [g̅_{k,i}^{(t)}= [symbol] ], (8)

respectively, where s_{ED}^{t,k,i} is a random quadrature phase-shift keying (QPSK) symbol and Eₛ=2 is the symbol energy. Note that a long-term power constraint, used for OBDA [10, Eq. 9 and Eq. 10], is not needed for FSK-MV as the OFDM symbol energy does not change as a function of CSI with FSK-MV. The ES receives the superposed symbols for a given i, respectively, as follows:

$${r}_{ES}^{t , s , {m}^{+} , {n}^{+}} = {\sum }_{k = 1 , {Δ}_{ED}^{t , k} > 0}^{K} \sqrt{{P}_{ED}^{s , k}} {h}_{UL}^{t , s , k , {m}^{+} , {n}^{+}} {t}_{ED}^{t , k , {m}^{+} , {n}^{+}} + {ω}_{ES}^{t , s , {m}^{+} , {n}^{+}} ,$$

$$and$$

$${r}_{ES}^{t , s , {m}^{-} , {n}^{-}} = {\sum }_{k = 1 , {Δ}_{ED}^{t , k} < 0}^{K} \sqrt{{p}_{ED}^{s , k}} {h}_{UL}^{t , s , k , {m}^{-} , {n}^{-}} {t}_{ED}^{t , k , {m}^{-} , {n}^{-}} + {ω}_{ES}^{t , s , {m}^{-} , {n}^{-}} .$$

The superposed symbols at the ES are then compared with an energy detector for the ith gradient to detect the MV as

v_{ES}^{t,s,i} =sign(Δ_{ES}^{t,s,i}), ∀i ∈{1, . . . , q}, (9)

where Δ_{ES}^{t,s,i} [symbol] |r_{ES}^{t,s, m+, n+}|²−|r_{ES}^{t,s, m-, n-}|²,

Finally, the ES transmits the MVs, i.e., V_{ES}^{t,s}=[v_{ES}^{t,s,l}, . . . , v_{ES}^{t,s,Q}]^{T}, to the EDs and the model parameters at the kth ED are updated as

wₖ^{(t+1)}=wₖ^{(t)}−ηv_{ED}^{t,k} (10)

This procedure is repeated for T communication rounds.

### MULTI-CELL OVER-THE-AIR COMPUTATION

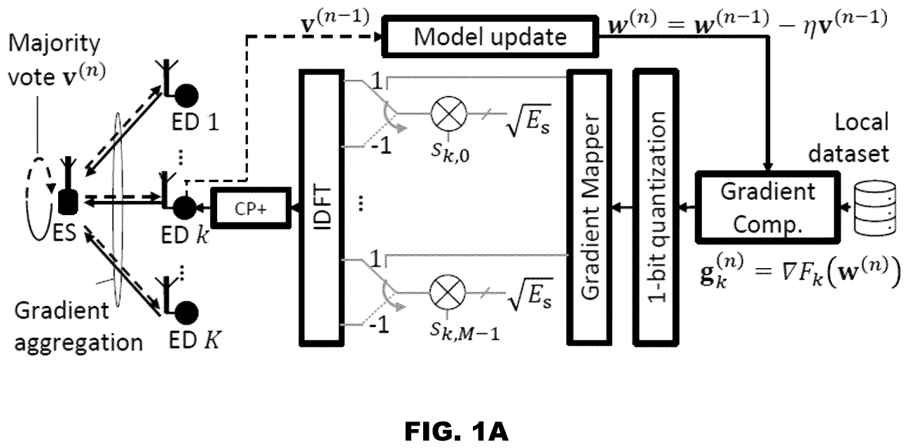

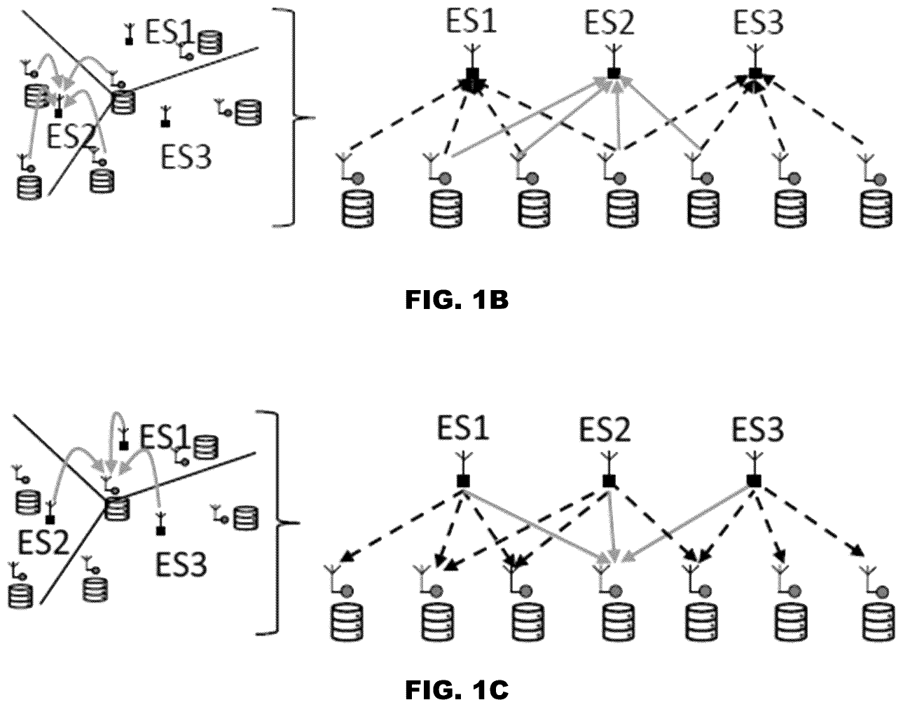

One of the major advantages of FSK-MV over other state-of-the-art OAC schemes (e.g., OBDA) is that EDs and ESs do not need to utilize the CSI. Also, it does not require precise time-synchronization among the transmitters since the computation with FSK-MV is achieved through a non-coherent detection in the frequency domain. FIG. 1A illustrates corresponding transmitter and receiver block diagrams for UL OAC with FSK-based majority vote (MV) (FSK-MV). These unique features enable us to extend FSK-MV in a multi-cell environment as the interference in both UL and DL can be exploited for computations. In the UL, the transmitted symbols from an ED superpose not only with the other EDs in the cell, but also with the ones at the neighboring cells. Therefore, the MV calculation at the ESs can exploit the interference from the EDs located at the neighboring cells, as illustrated in FIG. 1B. In particular, FIG. 1B illustrates a block diagram of UL features for OAC with multi-cell environment, illustrating interference across the cells (i.e., among the EDs or the ESs) as exploited in UL for gradient aggregation.

Similarly, in the DL, an ED (e.g., a cell-edge ED) can receive signals from multiple ESs. Hence, the inter-cell interference in the DL can also be used for the MV calculation at the EDs as depicted in FIG. 1C. In particular, FIG. 1C illustrates a block diagram of DL features for OAC with multi-cell environment, illustrating interference across the cells (i.e., among the EDs or the ESs) as exploited in DL for gradient aggregation. We discuss the operations at EDs and ESs in the following subsections in detail.

Algorithm 1: Multi-cell over-the-air computation

Function multiCellOAC

| \| | for t = 1 : T do | | |
|---|---|---|---|
| \| | \| | /* Processing @ EDs | |
| \| | \| | for k = 1 : K do | |
| \| | \| | \| | Determine r_{ED}^{t,k,m}^{⁺}^{,n}^{⁺}, r_{ED}^{t,k,m}^{^{−}}^{,n}^{^{−}}, ∀i |
| \| | \| | \| | Detect the MV at the ED, i.e, v_{ED}^{t,k,i}, ∀i |
| \| | \| | \| | Update the model parameter wₖ^{(t+1)} = wₖ^{(t)} − ηv_{ED}^{t,k}. |
| \| | \| | \| | Calculate local gradients based on (6) |
| \| | \| | └ | Calculate t_{ED}^{t,k,m}^{⁺}^{,n}^{⁺}, t_{ED}^{t,k,m}^{^{−}}^{,n}^{^{−}}, ∀i |
| \| | \| | /* Aggregation in the uplink channel | |
| \| | \| | EDs transmit the corresponding OFDM symbols simultaneously | |
| \| | \| | ESs receive the superposed OFDM symbols in the uplink | |
| \| | \| | /* Processing @ ESs | |
| \| | \| | for s = 1 : S do | |
| \| | \| | \| | Determine t_{ES}^{t,s,m}^{⁺}^{,n}^{⁺}, t_{ES}^{t,s,m}^{^{−}}^{,n}^{^{−}}, ∀i |
| \| | \| | \| | Detect the MV at the ES, i.e, v_{ES}^{t,s,i}, ∀i |
| \| | \| | └ | Calculate t_{ES}^{t,s,m}^{⁺}^{,n}^{⁺}, t_{ES}^{t,s,m}^{^{−}}^{,n}^{^{−}}, ∀i |

| | | |
|---|---|---|
| \| | \| | / * Aggregation in the downlink channel |
| \| | \| | ESs transmit the corresponding OFDM symbols simultaneously |
| └ | └ | EDs receive the superposed OFDM symbols in the downlink |

A. Uplink OAC with FSK-MV

In the UL, the expressions given for the transmitted symbols from the EDs and the superposed symbols at the ES with FSK-MV for a single cell, discussed in Section II-B, also hold in a multi-cell environment for S>1. After the sth ES calculates the vector v_{ES}^{t,s} ∀s, the DL OAC starts.

B. Downlink OAC with FSK-MV
1) Edge Servers-Transmitter: Similar to the UL OAC, we first consider distinct pairs (m+, n+) and (m−, n−) corresponding to the ith gradient. Based on the value of v_{ES}^{t,s}, at the tth communication round, the sth ES calculates the symbol t_{ES}^{t,s, m+, n+}and t_{ES}^{t,s,m-,n-}, ∀i, as

t_{ES}^{t,s,m+,n+}=\sqrt{Eₛ}s_{ES}^{t,s,i} [symbol] [v_{ES}^{t,s,i}= [symbol] ], (11)

and

t_{ES}^{t,s,m-,n-}=\sqrt{Eₛ}s_{ES}^{t,s,i} [symbol] [v_{ES}^{t,s,i}=− [symbol] ], (12)

respectively, where s_{ES}^{t,s,i} is a random QPSK symbol.

All ESs calculate the corresponding OFDM symbols and transmit them simultaneously for DL OAC.
2) Edge Device-Receiver: In the DL, the superposed symbols at the kth ED for all i can be expressed as

$${r}_{ED}^{t , k , {m}^{+} , {n}^{+}} = {\sum }_{s = 1 , {Δ}_{ES}^{t , s , i} > 0}^{S} \sqrt{{P}_{ES}^{s , k}} {h}_{DL}^{t , s , k , {m}^{+} , {n}^{+}} + {t}_{ED}^{t , s , {m}^{+} , {n}^{+}} + {ω}_{ED}^{t , s , {m}^{+} , {n}^{+}} ,$$

$$and$$

$${r}_{ED}^{t , k , {m}^{-} , {n}^{-}} = {\sum }_{s = 1 , {Δ}_{ES}^{t , s , i} < 0}^{S} \sqrt{{P}_{ES}^{s , k}} {h}_{DL}^{t , s , k , {m}^{-} , {n}^{-}} + {t}_{ED}^{t , s , {m}^{-} , {n}^{-}} + {ω}_{ED}^{t , s , {m}^{-} , {n}^{-}} .$$

The energy detector at the kth ED then detects the MV for the ith gradient as

v_{ED}^{t,k,i}=sign(Δ_{ED}^{t,k,i}), ∀i∈{1, . . . q}, (13)

where Δ_{ED}^{t,k,i} [symbol] |r_{ED}^{t,k,m+,n+}|²−|r_{ED}^{t,k,m-,n-}|².

Subsequently, the kth ED calculates the MV vector, i.e., v_{ED}^{t,k}=[v_{ED}^{t,k,1}, . . . , v_{ED}^{t,k, Q}]^{T} and updates its parameters as in Eq. (10). Hence, the parameters at the EDs are updated based on the received signals from multiple ESs.

C. Convergence Analysis

For the convergence analysis, we consider several standard assumptions made in the literature^{[10], [11]}:

Assumption 1 (Bounded loss function). Fₖ(Wₖ)≥F°, ∀Wₖ.

Assumption 2 (Smoothness). Let gₖ be the gradient of the personalized global loss function Fₖ (Wₖ) evaluated at wₖ. For all wₖ and w′ₖ, the expression given by

$$\vert {F}_{k} ( {w}_{k}^{′} ) - ( F ( {w}_{k} ) - {g}_{k}^{T} ( {w}_{k}^{′} - {w}_{k} ) ) \vert \leq \frac{1}{2} {\sum }_{i = 1}^{Q} {{L}_{i} ( {w}_{i}^{′} - {w}_{i} )}^{2} ,$$

holds for a non-negative constant vector L=[L₁, . . . , L_{Q}]^{T}.

Assumption 3 (Variance bound). Assume that the estimated gradient is an unbiased estimate of the true gradient, [symbol] [\tilde{g}ₖ]=gₖ, ∀k, and the variance of each component of them is bounded as [symbol] |(\tilde{g}_{k,i}−g_{k,i})²|≤σᵢ²/n_{b}, ∀k,i, where σ=[σ₁, . . . , σ_{Q}]^{T} is a non-negative constant vector.

Assumption 4 (Unimodal, symmetric gradient noise). For any given wₖ, the elements of the vector gₖ, ∀k, has a unimodal distribution that is also symmetric around its mean.

We also assume that the number of EDs that are connected to an ES, and the number of ESs that are connected to an ED, are fixed and denoted as K_{c}≤K and S_{c} ≤S, respectively (i.e., fixed-connectivity assumption). This assumption is due to the largescale fading in wireless channels, e.g., an ES can receive the strong signals from the EDs located at its adjacent ESs, but the ones from far cells are likely to be attenuated due to the large link distance. Based on this assumption, let Kₛ be the set of all EDs that are connected to the sth ES and Sₖ be the set of all ESs that are connected to the kth ED, where |Kₛ|=K_{c}, ∀ₖ, and |Sₖ|=S_{c}, ∀ₛ. We set the received power P_{ED}^{s,k}=1 for k ∈Kₛ, ∀ₛ, otherwise 0, and P_{ES}^{s,k}=1 for s ∈Sₖ, ∀ₖ, otherwise 0. This assumption does not hold for an irregular deployment. Nevertheless, it leads us to provide insight into multi-cell OAC with a tractable analysis since it results in |r_{ES}^{t,s,m+,n+}|² and |r_{ES}^{t,s,m-,n-}| to be exponential random variables with the means μ_{Es,i}⁺=E_{S}K_{S}⁺σ_{ES}² and μ_{ES, i}⁻=EₛKₛ⁻σ_{ES}², respectively, where K_{S}⁺ and Kₛ⁻ are the cardinalities of the sets {g̅_{k,i}^{(t)}=+1|k∈Kₛ} and {g̅_{k,i}^{(t)}=−1|k∈Kₛ}, respectively. Also, |r_{ED}^{t,k,m+,n+}|² and |r_{ED}^{t,k,m-,n-}|² become exponential random variables with the means μ_{ED,i}⁺=EₛSₖ⁺+σ_{ED}² and μ_{ED,i}⁻=EₛSₖ⁻+σ_{ED}², respectively, where Sₖ⁺ and Sₖ⁻ are the cardinalities of the sets {v_{ES}^{t,s,i}=+1|s∈ [symbol] ₖ}and {v_{ES}^{t,s,i}=−1|s∈ [symbol] ₖ}respectively. The distributions of Δ_{ED}^{t,s,i} and Δ_{ED}^{t,k,i} can then be calculated as Δ_{ES}^{t,s,i}˜f(x, μ_{ES,i}⁺, μES,i⁻) and Δ_{ED}^{t,k,i}˜f(y, μ_{ED,j}⁺, μ_{ED,i}⁻) respectively, where f(x, μ1, μ2) is xx e^{-x/μ}₁/(μ1 +μ2) for x>0, and otherwise it is e^{-x/μ}₂/(μ1+μ2)^{[15]}.

Theorem 1. For η=1/T and n_{b}=T/γ, the convergence rate of multi-cell OAC with FSK-MV in Rayleigh fading channel is:

$$𝔼 [ \frac{1}{T} {\sum }_{t = 0}^{T - 1} {‖ {g}_{k}^{( t )} ‖}_{1} ] \leq \frac{1}{( K - 2 A ) \sqrt{T}} ( {F}_{k} ( {w}_{k}^{( 0 )} ) - {F}^{*} + \frac{1}{2} K {‖ L ‖}_{1} + 2 \sqrt{γ} B \frac{\sqrt{2}}{3} {‖ σ ‖}_{1} ) . \qquad ( 14 )$$

where γ is a positive integer, A and B are defined as

$$A {=}^{△} \frac{1}{1 + {σ}_{ED}^{2}} - B and B {=}^{△} \frac{{S}_{c} ( {σ}_{ES}^{2} + {E}_{s} {K}_{c} )}{{E}_{s} ( {S}_{c} + 2 {σ}_{ED}^{2} ) ( {K}_{c} + 2 {σ}_{ES}^{2} )} ,$$

respectively.

Proof: The proof relies on the strategy used in prior art^{[11]}. By using Assumption 2 and using Eq. (9), it can be shown that:

$$𝔼 [ {F}_{k} ( {w}_{k}^{( t + 1 )} ] - {F}_{k} ( {w}_{k}^{( t )} ) ] \leq η K {‖ {g}_{k}^{( t )} ‖}_{1} + \frac{{η}^{2}}{2} K {‖ L ‖}_{1} + 2 η {\sum }_{k = 1}^{K} {\sum }_{i = 1}^{Q} \vert {g}_{k , i}^{( t )} \vert ℙ ( {v}_{ED}^{t , k , i} \neq {\hat{g}}_{k , i}^{( t )} ) ,$$

where Σₖ₌₁^{k}Σᵢ₌₁^{Q}|g_{k,i}^{(t)}| [symbol] (v_{ED}^{t,k,i}≠ĝ_{k,i}^{(t)}) is the stochasticity-induced error.

Let ĝ_{k, i}^{(t)} [symbol] sign(g_{k,i}^{(t)}) denote the correct decision and assume that ĝ_{k,i}^{(t)}=1. Also, let Y and Z be binomial random variables for the number of ESs and the number of EDs with the correct decision, i.e., Y˜(S_{c}, P_{y,i}) and Z˜B(K_{c}, p_{z,i}), where P_{y,i} and P_{z,i} denote the success probabilities. The probability P_{k,i}^{err} [symbol] [symbol] (v_{ED}^{t,k,i}≠ĝ_{k,i}^{(t)}) and the success probability p_{y,i} can then be written as

$${P}_{k , i}^{err} {\sum }_{{S}_{k}^{+} = 1}^{{S}_{c}} ( {v}_{ED}^{t , k , i} = - 1 \vert {\hat{g}}_{k , i}^{( t )} = 1 , Y = {S}_{k}^{+} ) ( Y = {S}_{k}^{+} ) , \qquad ( 15 )$$

$$and$$

$${p}_{y , i} = {\sum }_{{K}_{s}^{+} = 1}^{{K}_{c}} ( {v}_{ES}^{t , s , i} = 1 \vert {\hat{g}}_{k , i}^{( t )} = 1 , Z = {K}_{s}^{+} ) ( Z = {K}_{s}^{+} ) , \qquad ( 16 )$$

respectively.

Based on the distributions of Δ_{ES}^{t,s,i} and Δ_{ED}^{t,k,i}, we calculate the conditional probabilities in Eq. (15) and Eq. (16) as

$$( {v}_{ED}^{t , k , i} = - 1 \vert {\hat{g}}_{k , i}^{( t )} = 1 , Y = {S}_{k}^{+} ) = \frac{{μ}_{ED , i}^{-}}{{μ}_{ED , i}^{+} + {μ}_{ED , i}^{-}} , \qquad ( 17 )$$

$$and$$

$$( {v}_{ES}^{t , s , i} = 1 \vert {\hat{g}}_{k , i}^{( t )} = 1 , Z = {K}_{s}^{+} ) = \frac{{μ}_{ES , i}^{+}}{{μ}_{ES , i}^{+} + {μ}_{ES , i}^{-}} , \qquad ( 18 )$$

respectively.

By using the definitions of ^{μ}_{ES,i}⁺and ^{μ}_{ES,i}⁻and substituting Eq. (18) into Eq. (16), we obtain

$$\begin{matrix}{p}_{y , i} = {\sum }_{{K}_{s}^{+} = 1}^{{K}_{c}} \frac{{E}_{s} {K}_{s}^{+} + {σ}_{ES}^{2}}{{E}_{s} {K}_{c} + 2 {σ}_{ES}^{2}} ( \begin{matrix}{K}_{c} \\ {K}_{s}^{+}\end{matrix} ) {{p}_{z , i}^{{K}_{s}^{+}} ( 1 - {p}_{z , i} )}^{{K}_{c} - {K}_{s}^{+}} \\ = \frac{{E}_{s} {K}_{c} {p}_{z , i} + {σ}_{ES}^{2}}{{E}_{s} {K}_{c} + 2 {σ}_{ES}^{2}} .\end{matrix} \qquad ( 19 )$$

By substituting Eq. (17) into Eq. (15) and using Eq. (19), we obtain P_{k,i}^{err} as

$$( 20 )$$

$${P}_{i , k}^{err} = {\sum }_{{S}_{k}^{+} = 1}^{{S}_{c}} \frac{{E}_{s} {S}_{k}^{-} + {σ}_{ED}^{2}}{{E}_{s} {K}_{c} + 2 {σ}_{ED}^{2}} ( \begin{matrix}{S}_{c} \\ {S}_{k}^{+}\end{matrix} ) {p}_{y , i} {{S}_{k}^{+} ( 1 - {p}_{y , i} )}^{{S}_{c} - {S}_{k}^{+}} \leq \frac{{σ}_{ED}^{2} + {E}_{s} {S}_{c} ( 1 - \frac{{σ}_{ES}^{2} + {E}_{s} {K}_{c} ( 1 - \frac{\sqrt{2}}{3 S} )}{{E}_{s} {K}_{c} + 2 {σ}_{ES}^{2}} )}{{E}_{s} {S}_{c} + 2 {σ}_{ED}^{2}} ,$$

$$for S {=}^{△} \vert {g}_{k , i}^{( t )} \vert / \frac{σ}{\sqrt{{n}_{b}}} .$$

Accordingly, an upper bound for the stochasticity-induced error can be obtained as follows:

$${\sum }_{k = 1}^{K} {\sum }_{i = 1}^{Q} \vert {g}_{k , i}^{( t )} \vert {P}_{k , i}^{err} \leq A ∥ {g}_{k}^{( t )} {∥}_{1} + B \frac{\sqrt{2}}{\sqrt[3]{{n}_{b}}} ∥ σ {∥}_{1} , \qquad ( 21 )$$

where A and B are defined in Theorem 1.

By considering Assumption 1, an upper bound can then be obtained as follows:

$${F}^{*} = {F}_{k} ( {w}_{k}^{( 0 )} )$$

$$\leq 𝔼 [ {\sum }_{t = 0}^{T - 1} η K {‖ {g}_{k}^{( t )} ‖}_{1} + \frac{{η}^{2}}{2} K {‖ L ‖}_{1} + 2 η {\sum }_{k = 1}^{K} {\sum }_{i = 1}^{Q} \vert {g}_{k , i}^{( t )} \vert {P}_{k , i}^{err} ]$$

$$= 𝔼 [ {\sum }_{t = 0}^{T - 1} η ( K - 2 A ) {‖ {g}_{k}^{( t )} ‖}_{1} + \frac{{η}^{2}}{2} K {‖ L ‖}_{1} + 2 η B \frac{\sqrt{2}}{3 \sqrt{{n}_{b}}} {‖ σ ‖}_{1} ] .$$

Finally, by rearranging terms of the above equation and considering η=1/T and η_{b}=T/γ, Eq. (14) can be reached.

### NUMERICAL RESULTS

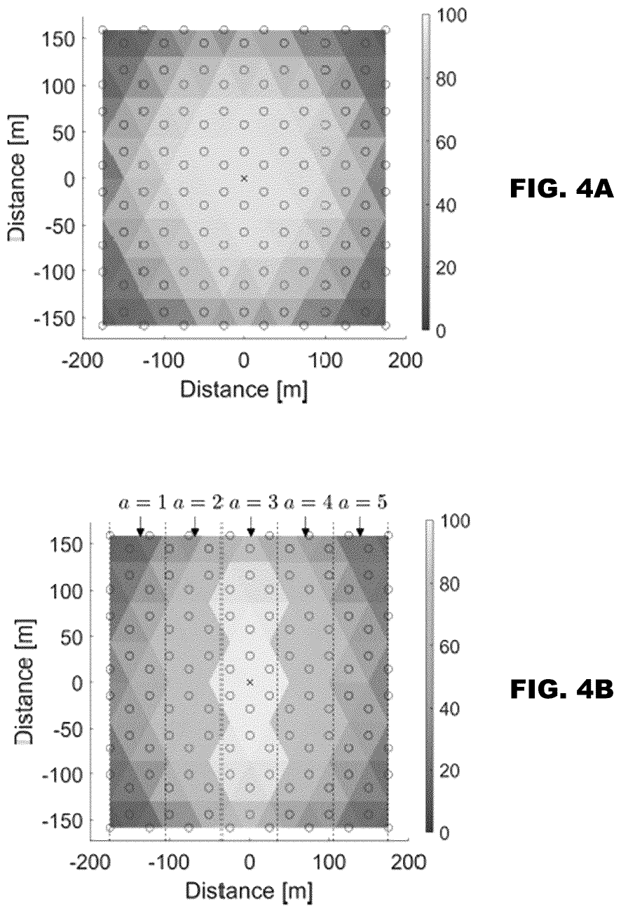

To numerically evaluate multi-cell OAC, we consider the learning task of handwritten-digit recognition over a hexagonal tessellation with 77 cells, i.e., S=77 ESs, where K=120 EDs are located at the cell edge and the distance between two adjacent ESs is 50 meters (see FIG. 4). Under this specific deployment, Kc and Sc are approximately 6 and 3, respectively. We do not assume a fixed connectivity assumption for the numerical analysis. The received signal powers are governed by the path loss model. Our evaluation is limited to FSK-MV since it is the only scheme that allows both OAC in both UL and DL, to the best of our knowledge. For the large-scale channel model, we assume that the path loss exponent is α=4 and the UL and DL SNRs are set to 20 dB for r_{UL}=r_{DL}=25/cos(π/6). For the fading channel, we consider ITU Extended Pedestrian A (EPA) with no mobility in both UL and DL and capture the long-term channel variations by regenerating the channels between the ESs and the EDs independently for each communication round. In this disclosure, we also assume that the UL and DL channel realizations are independent of each other. The subcarrier spacing and the CP duration are set to 15 kHz and 4.7 μs, respectively. We use M=1200 subcarriers (i.e., the signal bandwidth is 18 MHz). Therefore, T_{sync} can be calculated as 55.6 ns.

For the local data at the EDs, we use the MNIST database that contains labeled handwritten-digit images size of 28×28 from digit 0 to digit 9. We consider both homogeneous data and heterogeneous data distribution in the cell. To prepare the data, we first choose |G|∈{5000, 30000} training images from the database, where each digit has the identical number of images. For the scenario with the homogeneous data distribution, each local dataset has approximately an equal number of distinct images for each digit. For the scenario with the heterogeneous data distribution, we assume that the distribution of the images depends on the locations of the EDs. To this end, we divide the area into 5 identical parallel areas, where the EDs located in the αth area have the data samples with the labels {α−1, α, 1+α, 2+α, 3+α, 4+α} for α∈{1, . . . , 5} (see FIG. 4B). Hence, the availability of the labels gradually changes. The model at EDs is based on a convolution neural network (CNN) described in prior studies^{[15]}. It has Q=123090 learnable parameters, which corresponds to N=206 OFDM symbols in both UL and DL, respectively. The learning rate is 0.0001. The batch size η_{b} is 16. For the test accuracy calculation, we use 10,000 test samples available in the MNIST database. For the personalized test accuracy, we test the models based on only the classes available at the ED's local dataset.

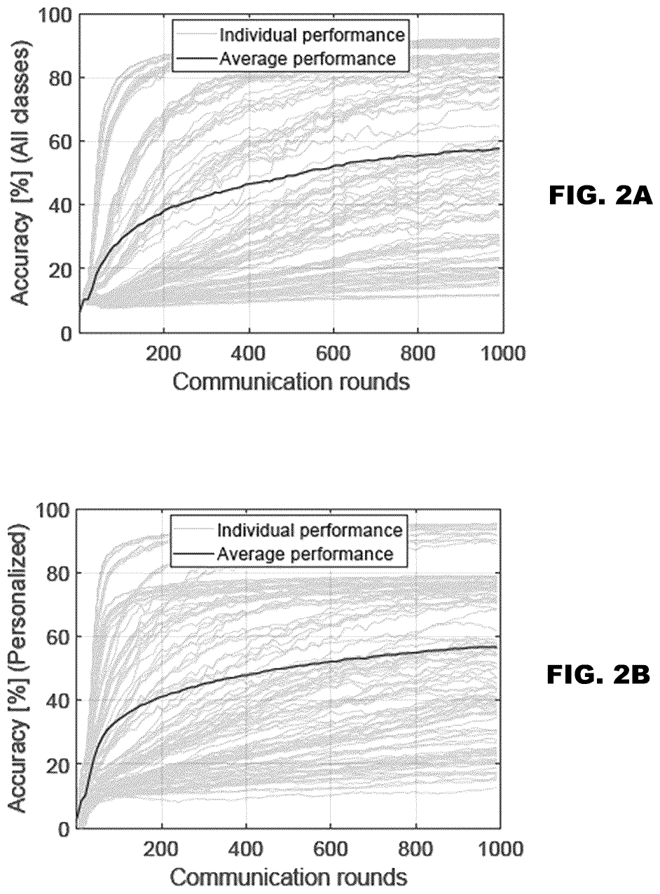

In FIGS. 2A and 2B, we evaluate the test accuracy versus communication round in a single cell under homogeneous and heterogeneous data distributions. When there is only a single ES for the aggregation and the data distribution in the area is homogeneous, only a few number of EDs obtain a high test accuracy, while a majority of EDs fail to recognize the digits as shown in FIG. 2A. In particular, FIG. 2A graphically illustrates test accuracy versus communication round in a single cell (|G|=30000) under homogeneous data distribution (all classes). The personalized test accuracy results for heterogeneous data distribution in FIG. 2B are also low (i.e., the EDs cannot even learn the classes that are available at their local datasets). In particular, FIG. 2B graphically illustrates test accuracy versus communication round in a single cell (|G|=30000) under heterogeneous data distribution (personalized).

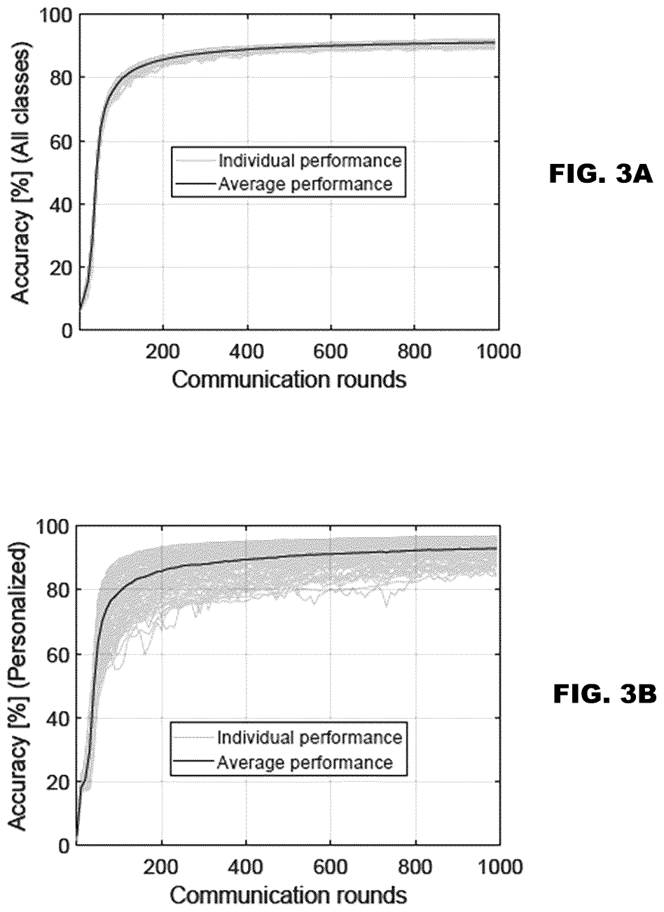

In FIGS. 3A and 3B, we consider multi-cell scenarios. When the data distribution is homogeneous, all EDs result in higher test accuracy results as demonstrated in FIG. 3A. In particular, FIG. 3A graphically illustrates test accuracy versus communication round for multiple cells (|G|=30000) under homogeneous data distribution (all classes). The personalized test accuracy is also high for the heterogeneous data distribution, as can be seen in FIG. 3B. In particular, FIG. 3B graphically illustrates test accuracy versus communication round for multiple cells (|G|=30000) under heterogeneous data distribution (personalized). This demonstrates that EDs learn to classify the labels while being harmonious with other EDs in the wireless network with the proposed OAC framework. FIGS. 3A and 3B show that the convergence for this specific learning task can be achieved after approximately 200 rounds. Thus, the amount of consumed time-frequency resources can be calculated as 2×(66.7+4.7)s×206×200=5.88 seconds over 18 MHz, respectively.

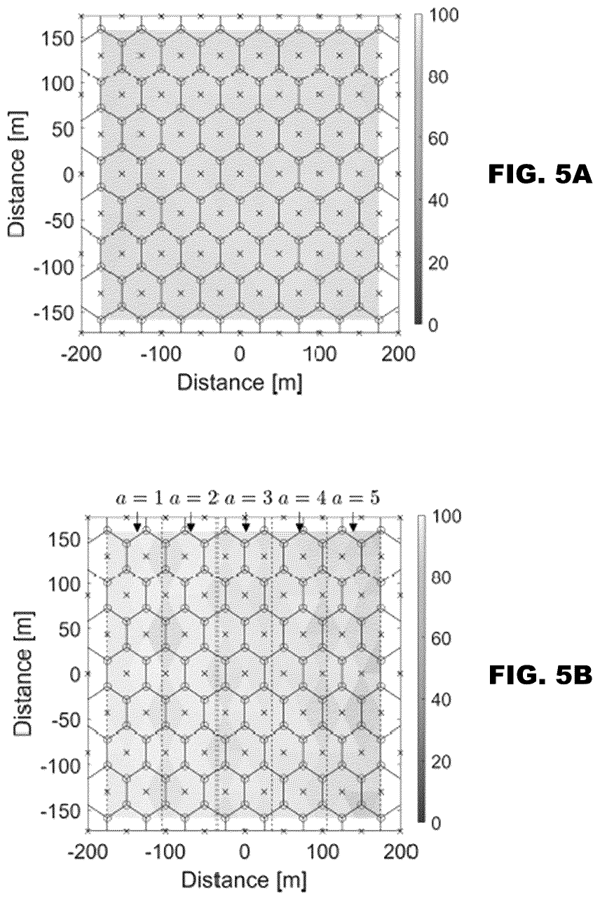

In FIG. 4A and FIG. 4B, we show the distribution of the test accuracy in the area. In particular, FIG. 4A graphically illustrates distribution of the test accuracy versus communication round in a single cell (×: ES, ○: ED, towards zero: Low test accuracy, towards 100: High test accuracy, |G|=30000) under homogeneous data distribution (all classes); and FIG. 4B graphically illustrates distribution of the test accuracy versus communication round in a single cell (×: ES, ○: ED, towards zero: Low test accuracy, towards 100: High test accuracy, |G|=30000) under heterogeneous data distribution (personalized). The single-cell OAC suffers from path loss: The far ED's votes cannot contribute the MV decision in the UL. Similarly, the ES's signal is not strong at the far EDs in the DL. Therefore, only nearby EDs get benefit from the FEEL and have similar data distribution. On the other hand, multi-cell OAC yields almost a uniform distribution for both homogeneous and heterogeneous data, as can be seen in FIG. 5A and FIG. 5B, respectively. In particular, FIG. 5A graphically illustrates distribution of the test accuracy versus communication round for multiple cells (×: ES, ○: ED, towards zero: Low test accuracy, towards 100: High test accuracy, |G|=30000) under homogeneous data distribution (all classes); and FIG. 5B graphically illustrates distribution of the test accuracy versus communication round for multiple cells (×: ES, ○: ED, towards zero: Low test accuracy, towards 100: High test accuracy, |G|=30000) under heterogeneous data distribution (personalized).

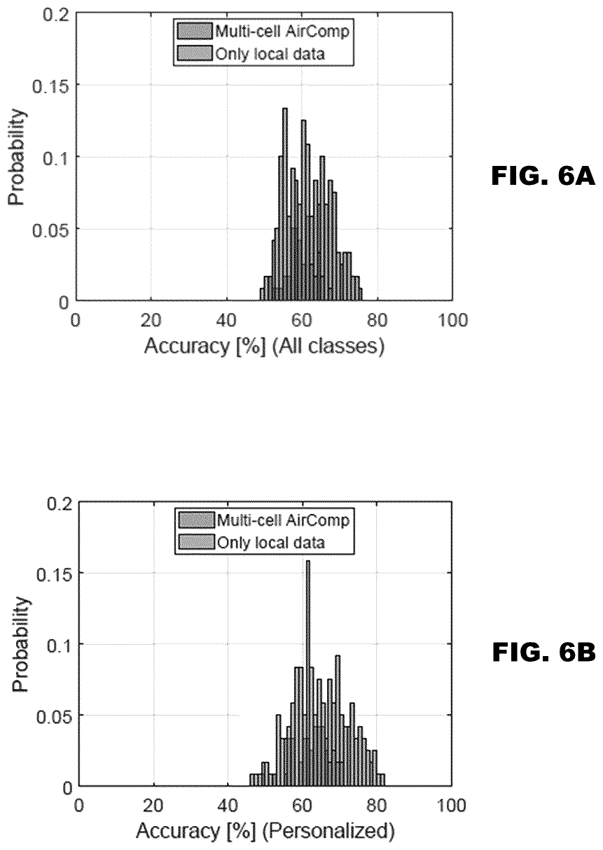

In FIGS. 6A and 6B, we evaluate if the proposed OAC method is superior to the case where each ED performs the training based on its own local data. The model at each ED is based on a convolution neural network (CNN). To this end, we intentionally reduce |G|to 5000 and set η=0.01 to demonstrate if the EDs are able to leverage the data at the neighboring EDs through FEEL. We plot the histogram of the test accuracy after 400 iterations for both cases. The results show that, in both homogeneous and heterogeneous data distributions, the proposed concept improves the average test accuracy based on all classes and personalized test accuracy in this scenario. In particular, FIG. 6A graphically illustrates distribution of the test accuracy versus probability for multi-cell federated learning (FL) with the proposed OAC with the training based on only local data after 400 iterations (|G|=5000) under homogeneous data distribution (all classes); and FIG. 6B graphically illustrates distribution of the test accuracy versus probability for multi-cell FL with the proposed OAC with the training based on only local data after 400 iterations (|G|=5000) under heterogeneous data distribution (personalized).

### CONCLUDING REMARKS

In this disclosure, we present a multi-cell OAC framework where the aggregations occur in both UL and DL across multiple cells through a non-coherent OAC scheme, i.e., FSK-MV. We also prove the convergence of FEEL under a fixed-connectivity assumption. Finally, we evaluate the test accuracy of the multi-cell OAC by comparing it with the one for a single-cell scenario for homogeneous and heterogeneous data distributions. Our numerical results show that the proposed approach is a promising solution to achieve a high-test accuracy at the EDs by exploiting the interference among multiple cells. In this disclosure, our analysis is based on regular tessellation. For an irregular deployment, the interference distributions in UL and DL need to be considered for the convergence analysis, which will be investigated in future work.

While certain embodiments of the disclosed subject matter have been described using specific terms, such description is for illustrative purposes only, and it is to be understood that changes and variations may be made without departing from the spirit or scope of the subject matter.

### REFERENCES

^{[1]}B. Nazer and M. Gastpar, “Computation over multiple-access channels,” IEEE Trans. Inf. Theory, vol. 53, no. 10, pp. 3498-3516, October 2007.
^{[2]}M. Goldenbaum, H. Boche, and S. Stanczak, “Harnessing interference for analog function computation in wireless sensor networks,” IEEE Trans. Signal Process., vol. 61, no. 20, pp. 4893-4906, October 2013.
^{[3]}M. Tang, S. Cai, and V. K. N. Lau, “Remote state estimation with asynchronous mission-critical IoT sensors,” IEEE Journal on Selected Areas in Communications, vol. 39, no. 3, pp. 835-850, August 2021.
^{[4]}L. Chen, X. Qin, and G. Wei, “A uniform-forcing transceiver design for over-the-air function computation,” IEEE Wireless Communications Letters, vol. 7, no. 6, pp. 942-945, May 2018.
^{[5]}T. Gafni, N. Shlezinger, K. Cohen, Y. C. Eldar, and H. V. Poor, “Federated learning: A signal processing perspective,” 2021. [Online]. Available: arXiv:2103.17150
^{[6]}M. Chen, D. Gündüz, K. Huang, W. Saad, M. Bennis, A. V. Feljan, and H. Vincent Poor, “Distributed learning in wireless networks: Recent progress and future challenges,” IEEE J. Sel. Areas Commun., pp. 1-26, 2021.
^{[7]}L. Liu, J. Zhang, S. Song, and K. B. Letaief, “Client-edge-cloud hierarchical federated learning,” in ICC 2020-2020 IEEE International Conference on Communications (ICC), 2020, pp. 1-6.
^{[8]}G. Zhu, Y. Wang, and K. Huang, “Broadband analog aggregation for low-latency federated edge learning,” IEEE Trans. Wireless Commun., vol. 19, no. 1, pp. 491-506, January 2020.
^{[9]}M. M. Amiri and D. Gündüz, “Federated learning over wireless fading channels,” IEEE Trans. Wireless Commun., vol. 19, no. 5, pp. 3546-3557, February 2020.
^{[10 ]}G. Zhu, Y. Du, D. Gündüz, and K. Huang, “One-bit over-the-air aggregation for communication-efficient federated edge learning: Design and convergence analysis,” IEEE Trans. Wireless Commun., vol. 20, no. 3, pp. 2120-2135, November 2021.
^{[11]}J. Bernstein, Y.-X. Wang, K. Azizzadenesheli, and A. Anandkumar, “signSGD: Compressed optimisation for non-convex problems,” in Proc. in International Conference on Machine Learning, vol. 80. Proceedings of Machine Learning Research, 10-15 Jul. 2018, pp. 560-569.
^{[12]}L. Su and V. K. N. Lau, “Hierarchical federated learning for hybrid data partitioning across multitype sensors,” IEEE Internet of Things Journal, vol. 8, no. 13, pp. 10 922-10 939, January 2021.
^{[13]}K. Yang, T. Jiang, Y. Shi, and Z. Ding, “Federated learning via over- the-air computation,” IEEE Trans. Wireless Commun., vol. 19, no. 3, pp. 2022-2035, 2020.
^{[14]}M. M. Amiria, T. M. Duman, D. Gündüz, S. R. Kulkarni, and H. Vin-cent Poor, “Collaborative machine learning at the wireless edge with blind transmitters,” IEEE Trans. Wireless Commun., pp. 1-1, March 2021.
^{[15]}A. Sahin, B. Everette, and S. Hogue, “Distributed learning over a wire-less network with FSK-based majority vote,” in Proc. IEEE International Conference on Advanced Communication Technologies and Networking (CommNet), December 2021, pp. 1-9.
^{[16]}Sahin et al., “Over-the-air computation with DFT-spread OFDM for federated c. IEEE Wireless Communications and Networking Conference (WCNC), March 2022, pp. 1-6.

What is claimed is:

1. A non-coherent over-the-air computation methodology occurring in both uplink (UL) and downlink (DL), sequentially, in a multi-cell environment for federated edge learning (FEEL) without using channel state information (CSI) at a plurality of edge devices (EDs) or at edge servers (ESs), comprising:
providing a distributed machine-learning model to be trained with the update vectors received at a plurality of edge servers (ESs) as transmitted from a plurality of edge devices (EDs); and
performing methodology operations comprising:
transmitting local updates vectors as weighted votes with respective of the plurality of edge servers (ESs) functioning as aggregation nodes in the UL via a wireless multi-cell environment,
independently detecting orthogonal signaling based majority vote (MV) data at each ES in the UL,
broadcasting the detected MVs from the ESs, and
inputting the MVs into the machine-learning model to be updated,
wherein the EDs determine the sign of the gradient through over-the-air computation using orthogonal signaling based majority vote (MV) in the DL.

2. The non-coherent over-the-air computation methodology according to claim 1, wherein the votes comprise orthogonal frequency division multiplexing (OFDM) symbols over multiple OFDM subcarriers, and aggregating operations use one-bit broadband digital aggregation (OBDA) and frequency-shift keying (FSK)-based methodology.

3. The non-coherent over-the-air computation methodology according to claim 2, wherein the orthogonal signaling at the EDs in the UL and at the ESs in the DL may be frequency-shift keying (FSK), and access the wireless channel on the same time-frequency resources simultaneously with N OFDM symbols consisting of M active subcarriers.

4. The non-coherent over-the-air computation methodology according to claim 1, further including exploiting interference in the multi-cell environment in both UL and DL for computations.

5. The non-coherent over-the-air computation methodology according to claim 4, wherein:
transmitted symbols from an ED superpose with other EDs in the cell, and with EDs in neighboring cells; and
the MV calculation at the ESs in the UL exploits interference from the EDs located in the neighboring cells.

6. The over-the-air computation methodology according to claim 4, wherein:
transmitted symbols from multiple ESs are received by a cell-edge ED; and
the MV calculation at the EDs in the DL exploits inter-cell interference in the DL from the multiple ESs.

7. The over-the-air computation methodology according to claim 1, wherein the machine learning model comprises artificial intelligence technology over wireless or sensor networks, 5G or higher, 6G wireless standardization, or IEEE 802.11 Wi-Fi.

8. The over-the-air computation methodology according to claim 1, wherein for a fading channel, long-term channel variations are captured by regenerating the channels between the ESs and the EDs independently for each communication round.

9. The over-the-air computation methodology according to claim 1, wherein the UL and DL channel realizations are independent of each other.

10. The over-the-air computation methodology according to claim 3, wherein the subcarrier spacing and the cyclic prefix (CP) duration are set to about 15 kHz and 4.7 μs, respectively.

11. The over-the-air computation methodology according to claim 3, wherein the number of M active subcarriers equals at least 1000 subcarriers.

12. The over-the-air computation methodology according to claim 1, wherein the machine-learning model is training to learn the task of handwritten-digit recognition.

13. The over-the-air computation methodology according to claim 12, wherein the machine-learning model comprises a convolution neural network with multiple convolutional layers.

14. The non-coherent over-the-air computation methodology according to claim 1, further comprising:
providing one or more processors; and
providing one or more non-transitory computer-readable media that store instructions that, when executed by the one or more processors, cause the one or more processors to perform the methodology operations.

15. A non-coherent over-the-air computation system for both uplink (UL) and downlink (DL) channels in a multi-cell environment, for federated edge learning (FEEL) without using channel state information (CSI) at a plurality of edge devices (EDs) or at edge servers (ESs), comprising:
a machine-learning model training to process data received at a plurality of edge servers (ESs) as transmitted from a plurality of edge devices (EDs);
one or more processors; and
one or more non-transitory computer-readable media that store instructions that, when executed by the one or more processors, cause the one or more processors to perform operations, the operations comprising:
transmitting local update vectors as weighted votes with respective of the plurality of edge servers (ESs) functioning as aggregation nodes in the UL channel via a wireless multi-cell environment,
independently detecting orthogonal signaling based majority vote (MV) data at each ES in the UL channel,
broadcasting the detected MVs from the ESs, and
inputting the MVs into the machine-learning model to be updated,
wherein the EDs determine the sign of the gradient through over-the-air computation using orthogonal signaling based majority vote (MV) in the DL channel.

16. The non-coherent over-the-air computation system according to claim 15, wherein the votes comprise orthogonal frequency division multiplexing (OFDM) symbols over multiple OFDM subcarriers, and aggregating operations use one-bit broadband digital aggregation (OBDA) and frequency-shift keying (FSK)-based methodology.

17. The non-coherent over-the-air computation system according to claim 16, wherein the orthogonal signaling at the EDs in the UL and the ESs in the DL may be FSK and access the wireless channel on the same time-frequency resources simultaneously with N OFDM symbols consisting of M active subcarriers.

18. The non-coherent over-the-air computation system according to claim 15, wherein the operations further include exploiting interference in the multi-cell environment in both UL and DL channels for computations.

19. The non-coherent over-the-air computation system according to claim 15, wherein the MV detection at the ESs in the UL exploits interference from the EDs located in neighboring cells.

20. The non-coherent over-the-air computation system according to claim 15, wherein the MV calculation at the EDs in the DL channel exploits inter-cell interference in the DL channel from the multiple ESs.

21. The non-coherent over-the-air computation system according to claim 15, wherein the machine learning model comprises artificial intelligence technology over wireless or sensor networks, 5G or higher, 6G wireless standardization, or IEEE 802.11 Wi-Fi.

22. The non-coherent over-the-air computation system according to claim 15, wherein the UL and DL channel realizations are independent of each other.

23. The non-coherent over-the-air computation system according to claim 15, wherein the machine-learning model comprises a convolution neural network with multiple convolutional layers.
